(19) United States
(12) Patent Application Publication
(10) Pub. No.: US 2023/0148579 A1
(43) Pub. Date: May 18, 2023

(54) Float Fishing Apparatus

(71) Applicant: Strike King Lure Company, LLC, Collierville, TN (US)

(72) Inventor: Crispin Powley, Collierville, TN (US)

(73) Assignee: Strike King Lure Company, LLC, Collierville, TN (US)

(21) Appl. No.: 17/525,003

(22) Filed: Nov. 12, 2021

(51) Int. Cl. A01K 93/00; A01K 91/08

(52) U.S. Cl. CPC A01K 93/00; A01K 91/08

(57) ABSTRACT

One aspect of the disclosure includes a float fishing apparatus having an elongated connecting member and a float. The float has a body portion with a forward end and a rearward end. The body portion has an opening extending therethrough with the connecting member passing slidably through the opening. The body portion is rotatably mounted on the connecting member. The float has a fin member extending from the body portion. The fin member has a leading edge and a spaced trailing edge with a pressure surface extending therebetween. The pressure surface of the fin member responds to water pressure when the float is moved through water to rotate the float and intermittently splash the water. In some forms the fin member extends around only a portion of the body portion of the float such that the float has an asymmetrical shape.

### BACKGROUND

A wide variety of fishing tackle exists on the market today. The type of fishing tackle used generally depends upon personal choices of the angler, the species of fish sought, lighting, water conditions, season, availability, fishing style, and other factors.

Popping floats (also referred to as popping corks) are one type of fishing tackle used to produce strikes. A popping float is typically a two to six-inch-long float made of cork, Styrofoam, hard plastic, or other buoyant material. Many popping floats are cupped with a concave-shaped front end to create loud “chugs” and “popping” sounds when the angler pulls the float quickly through the water. A concave front of the popping cork displaces more water, resulting in louder sounds and more splashing action. The opposite end of the popping float is often tapered and weighted to make it easier to cast and keep the trail end of the float below the surface of the water.

The theory behind popping floats is that fish are attracted to commotion at the surface of the water, as the noise simulates an injured fish or surface feeding bait fish fleeing from predators. When fish come to investigate the sounds, they see the lure dangling below the float and strike.

The retrieval cadence and loudness of the “pops” can be important to attracting fish. A common technique for anglers is to cast the popping float to where fish are likely to be. The angler then pulls abruptly on (or “pops”) the float once or multiple times and then pauses before repeating the process as the angler reels the float with the lure across the strike zone. One problem with existing popping floats is that the popping sound and splash of the water predictably follows as the angler pulls on the line with a jerking motion of the rod. The float does not allow for a more random noise and splashing action. Instead, the noise and splash are limited by the angler's retrieval action. A more random and intermittent noise and splash is sometimes desired. Further, existing popping floats only make a splashing sound when the angler abruptly pulls or jerks the line. In other words, a continuous or slow retrieval of the line would typically not make any fish-attracting noises. It would sometimes be desirable to generate sounds and splashes at the surface of the water without requiring a jerking motion during retrieval.

There is therefore a need for an improved float fishing apparatus that overcomes these and other problems in the art.

### SUMMARY

One aspect of the disclosure includes a float fishing apparatus having an elongated connecting member and a float. The float has a body portion with a forward end and a rearward end. The body portion is rotatably combined with the connecting member. In one embodiment the body portion has an opening extending therethrough with the connecting member passing slidably through the opening so that the body portion is rotatably combined with the connecting member. The float has a fin member extending from the body portion. The fin member has a leading edge and a spaced trailing edge with a pressure surface extending therebetween. The pressure surface of the fin member responds to water pressure when the float is moved through water to rotate the float and intermittently splash the water. In some forms, the pressure surface has a generally concave shape, and the fin member extends around only a portion of the body portion of the float such that the float has an asymmetrical shape.

Another aspect of the disclosure includes a float fishing apparatus having an elongated connecting member and a float. The float has a body portion with a forward end and a rearward end. The body portion has an opening extending therethrough with the connecting member passing slidably through the opening so that the body portion is rotatably combined with the connecting member. The float has a fin member extending from the body portion. The fin member has a leading edge and a spaced trailing edge with a pressure surface extending therebetween. The float also includes a second body portion spaced apart from and positioned rearward of the first body portion on the connecting member. The pressure surface of the fin member responds to water pressure when the float is moved through water to rotate the first body portion of the float and intermittently splash the water with the fin member.

Another aspect of the disclosure includes a float fishing apparatus having an elongated connecting member and a float. The float has a first body portion with a forward end and a rearward end. The body portion has an opening extending therethrough with the connecting member passing slidably through the opening so that the body portion is rotatably mounted on the connecting member. The float has a first fin member extending from the first body portion. The first fin member has a leading edge and a spaced trailing edge with a pressure surface extending therebetween. The float also includes a second body portion spaced apart from and positioned rearward of the first body portion on the connecting member. A second fin member extends from the second body portion. The pressure surface of the first fin member responds to water pressure when the float is moved through water to rotate the first body portion of the float and intermittently splash the water with the fin member, and the pressure surface of the second fin member responds to water pressure when the float is moved through the water to rotate the second body portion of the float and intermittently splash the water. In some forms, the first fin member is configured to rotate the first body portion in a first direction and the second fin member is configured to rotate the second body portion in a second, opposite direction. The first and second fin members may also, in some embodiments, be sized and/or shaped differently to rotate the first and second body portions at different speeds.

A still further aspect of the disclosure includes a method of fishing using a float fishing apparatus. The method includes taking a float fishing apparatus having an elongated connecting member and a float. The float has a body portion with a forward end and a rearward end. The body portion has an opening extending therethrough with the connecting member passing slidably through the hole so that the body portion is rotatably mounted on the connecting member. The float has a fin member extending from the body portion. The fin member has a leading edge and a spaced trailing edge with a pressure surface extending therebetween. The method further includes securing a lure to one of the first and second ends of the connecting member nearest the rearward end of the body portion of the float and casting the float fishing apparatus with the lure. As the angler moves the float through the water, the pressure surface of the fin member responds to water pressure to rotate the float and intermittently splash the water. In some forms, the float can include a first body portion and a second body portion, each having a fin member configured to rotate the body portion in the water and intermittently splash the surface of the water.

### BRIEF DESCRIPTION OF THE DRAWINGS

FIG. 1 is a perspective view of the float fishing apparatus.

FIG. 2 is a side view of the float fishing apparatus.

FIG. 3 is a top view of the float fishing apparatus.

FIG. 4 is a side view of an alternative embodiment of the float fishing apparatus.

FIG. 5 is a side view of another alternative embodiment of the float fishing apparatus.

FIG. 6 is a side view of the float fishing apparatus with attached lure when in use.

### DETAILED DESCRIPTION

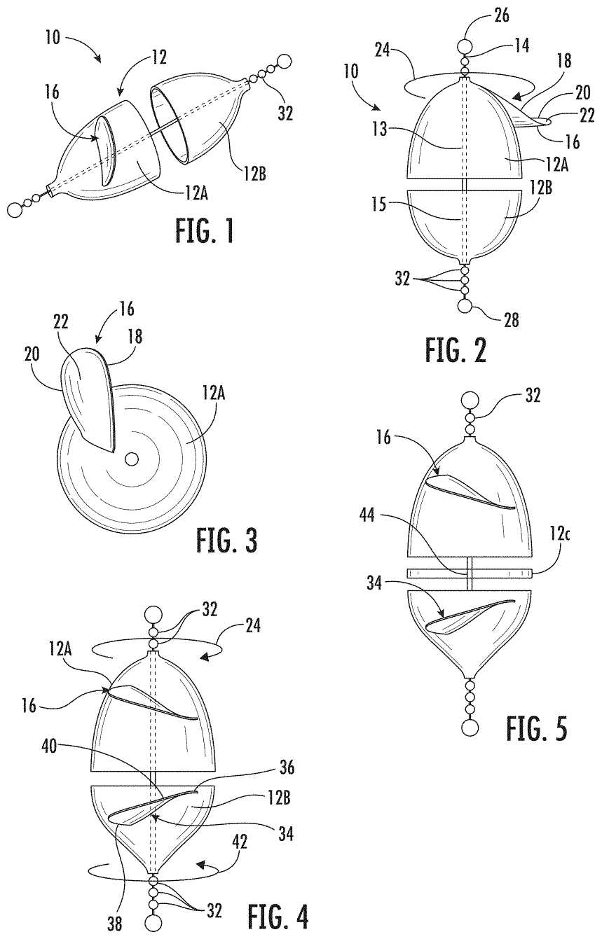

FIG. 1 is a perspective view of an embodiment of the float fishing apparatus according to the present invention. The float fishing apparatus includes a popping float 10 having a body portion 12. Some embodiments include single body portion 12 and other embodiments include a first body portion 12A and a second body portion 12B. The first body portion 12A is near a front of the popping float 10, and the second body portion 12B is rearward of the first portion 12A. The first and second body portions 12A, 12B may be made from cork, Styrofoam, or a hard plastic, such as polyethylene (PE), polyvinyl chloride (PVC), acrylonitrile butadiene styrene (ABS) or other buoyant material.

As shown in FIG. 2, the first body portion 12A and the second body portion 12B have a longitudinal axis which may extend along a centerline of each body portion 12A, 12B. A first channel or opening 13 (shown in dashed lines) extends through a least a portion of the first body portion 12A and a second channel or opening 15 (shown in dashed lines) extends through at least a portion of the second body portion 12B. The first opening 13 and second opening 15 may extend along the centerline of each respective body portion 12A, 12B. A connecting member 14, such as a rod or wire, passes slidably through the opening 13 in the first body portion 12A and through the opening 15 in the second body portion 12B.

A fin member 16 extends from the periphery of the first body portion 12A. In some embodiments the fin member 16 extends outward from the first body portion 12A at an angle that is generally perpendicular to the longitudinal axis of the first body portion 12A. The fin member 16 includes a leading edge 18 and a trailing edge 20 with a pressure surface 22 located between the leading and trailing edges 18, 20. As explained below in more detail, the pressure surface 22 is shaped like the surface of a propeller blade to engage the water 46 at an angle causing the fin member 16 to rotate as it is pulled through the water 46. In some embodiments the pressure surface 22 may be shaped in a spiral plane. The pressure surface 22 may have a shape that causes rotation in either a clockwise or counter clockwise direction depending on the angle (configuration of the leading and trailing edges). The first body portion 12A and the fin member 16 may be integrally formed or they may be manufactured separately then combined together.

The first body portion 12A is rotatably combined with the connecting member 14. When the popping float 10 is pulled through the water while fishing, the first body portion 12A and the second body portion 12B displace water, creating a disturbance in the water and a resulting sound. In addition, as the leading edge 18 of the fin member 16 engages the water, the pressure surface 22 responds to frictional forces exerted by the water 46 on the fin member 16, causing the fin member 16 and the first body portion 12A to rotate in the direction indicated by the directional arrow 24. As the fin member 16 continues to rotate, the pressure surface 22 intermittently slaps the water, creating an additional disturbance in the water and a resulting sound. The pressure surface 22 of the fin member 16 slaps the water once per revolution. The leading edge 18 of the fin member 16 continues to cut through and engage the water as a portion of the fin member 16 extends out of the water, thus continuing to rotate the fin member 16 and the first body portion 12A.

The pressure surface 22 of the fin member 16 may have a generally concave shape, as illustrated in FIG. 3. In one embodiment only a single fin member 16 is combined with the first body portion 12A. The fin member 16 extends around only a portion of the periphery of the first body portion 12A, giving the popping float 10 an asymmetrical shape. For example, in some embodiments the fin member 16 extends less than 180 degrees around the circumference of the first body portion 12A thereby promoting a slapping action on the water each time the fin member 16 with pressure surface 22 rotates. In this embodiment the slapping action is intermittent (not continuous) since the single fin member 16 extends less than 180 degrees around the circumference of the first body portion 12A.

The forward end of the first body portion 12A shown in FIG. 2 has a generally convex shape. However, if more water displacement is desired, the forward end of the first body portion 12A can have a flat or concave shape.

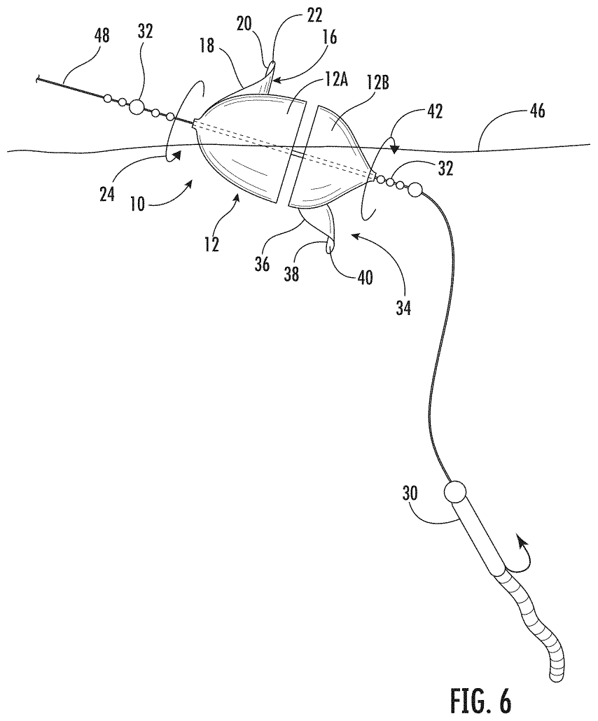

The connecting member 14 in the form shown in the Figures includes a first line attachment member 26 at one end and a second line attachment member 28 at the opposite end. Fishing line 48 secured to the first line attachment member 26 extends to the angler's rod and reel (not shown). A lure 30 is secured to the second line attachment member 28, as shown in FIG. 6. A variety of lures are suitable for use with the popping float, as is known in the art.

Beads 32 can be mounted toward opposite ends of the connecting member 14. The beads 32 are preferably made of plastic and help prevent the first and second line attachment members 26, 28 from jamming inside the openings 13, 15 in the first and second body portions 12A, 12B or cracking and breaking the body portions during fishing.

FIG. 4 is an alternative embodiment of the fishing float apparatus that makes use of multiple fin members. As described previously, a first fin member 16 extends from the first body portion 12A. This alternative embodiment includes a second fin member 34 extending from the second body portion 12B. The second fin member 34 has a leading edge 36 and a trailing edge 38 with a pressure surface 40 that extends between the two edges. As the leading edge 36 of the second fin member 34 engages the water, the pressure surface 40 responds to forces exerted on the second fin member, causing the fin member 34 and the second body portion 12B to rotate in the direction indicated by the directional arrow 42. As the second fin member 34 continues to rotate, the pressure surface 40 intermittently slaps the water, creating an additional disturbance in the water and a resulting sound. Like the first fin member 16, the pressure surface 40 of the second fin member 34 slaps the water once per revolution. The leading edge 36 of the second fin member 34 continues to cut through and engage the water as a portion of the second fin member extends out of the water, thus continuing to rotate the second fin member and the second body portion 12B.

As illustrated in FIG. 4, the first fin member 16 and the second fin member 34 are configured to rotate the first body member 12A and the second body member 12B in opposite directions, as indicated by the directional arrows 24 and 42. The angle of the pressure surfaces 22, 40 are reversed so that one of the body members 12A, 12B rotates clockwise and the other body member 12A, 12B rotates counter clockwise. Rotating the first and second body members 12A, 12B in opposite directions helps promote a straighter line of retrieval when the angler retrieves the popping float since each fin member 16, 34 is pulling its respective body member 12A, 12B in a different direction. The first and second fin members 16, 34 can alternatively be configured to rotate the first and second body members 12A, 12B in the same direction if a different retrieval path is desired.

The first and second fin members 16, 34 can also be sized or shaped differently to rotate the first and second body portions 12A, 12B at different speeds and/or create different splashing noises in the water 46. For example, in one embodiment the first fin member 16 has a first rake angle and the second fin member 34 has a second rake angle that is different from the first rake angle. The different rake angles cause the fin members 16, 34 to rotate at different speeds and/or create different splashing sounds. In another embodiment the first fin member 16 has a first pitch angle and the second fin member 34 has a second pitch angle that is different from the first pitch angle. The different pitch angles cause the fin members 16, 34 to rotate at different speeds and/or create different splashing sounds. In yet another embodiment the first fin member 16 has a first mass and the second fin member 34 has a second mass that is different from the first mass. The different masses cause the fin members 16, 34 to rotate at different speeds and/or create different splashing sounds. In yet another embodiment the first fin member 16 extends a first distance around the first body portion 12A and the second fin member 34 extends a second distance around the second body portion 12B that is different from the first distance. The different lengths cause the fin members 16, 34 to rotate at different speeds and/or create different splashing sounds. The first and second distance may both be less than 180 degrees around the circumference of each respective body portion 12A, 12B. In other embodiments one or both of the first and second distances may extend more than 180 degrees around the circumference of the respective body portion 12A, 12B.

FIG. 5 shows a variation where the body portion 12 includes a third body portion 12C disposed between the first body portion 12A and the second body portion 12B. The connecting member 14 passes through an opening 44 (shown in dashed lines) of the third body portion 12C. The third body portion 12C is positioned between the first body portion 12A and the second body portion 12B. In some cases it may be desirable to decrease the amount of sound created by the first body portion 12A and/or the second body portion 12B. In order to maintain the desired buoyancy of the popping float 10, the size of the third body portion 12C may be increased when the size of the first and/or second body portions 12A, 12B are decreased.

During use, the angler casts the popping float 10 with a lure 30 to where fish are likely to be. The popping float is oriented in an upright position (as shown in FIG. 4) with the first body portion 12A above the second body portion 12B. The upright orientation may be caused by the weight of the lure 30 pulling downward on its connection to the connecting member 14. In other embodiments the upright orientation is caused by weights or a weight transfer device (such as weighted beads or raddles) inside the second body portion 12B. The angler then pulls or “pops” the popping float 10 once or multiple times and then pauses before repeating the process as the angler reels the float 10 with the lure 30 across the strike zone. When the angler pulls on the line 48, the popping float 10 transitions to a more horizontal orientation because the line 48 is being pulled at a small angle relative to the surface of the water, such as shown in FIG. 6. As also shown in FIG. 6, in some embodiments the buoyancy of the both body portions 12A, 12B is such that the more horizontal orientation causes the leading or front end of the first body portion 12A to be at least partially under the surface of the water 46 when the angler is pulling on the line 48. The partial submersion of the float 10 is furthered by the fin members 16, 34 creating a drag or frictional force in a direction opposite the angler's pulling force. The partial submersion of the float 10 helps the fin members 16, 34 continue to frictionally engage the water 46 causing rotation during retrieval. A popping sound and splash of the water 46 follows as the angler pulls on the line 48 and the body portion 12 moves through the water 46. In addition to the water displaced by the body portion 12 of the float 10, the first and second fin members 16, 34 rotate on the first and second body portions 12A, 12B, slapping the water intermittently with each rotation. As such, as opposed to a constant, continuing noise or splash dictated by the angler's retrieval pattern, the fin members 16, 34 create a more random and intermittent noise and splash pattern.

The popping float 10 shown in FIG. 6. features a fin member 16, 34 on each of the first and second body portions 12A, 12B. The popping float 10 can also be used with only a single fin member, such as described above with respect to FIG. 2. The fin members 16, 34 can also be sized and shaped to vary the direction and speed at which the fin members 16, 34 and body portions 12A, 12B rotate, as previously described.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A float fishing apparatus, comprising:
an elongated connecting member having a first end and a second end;
a float having a body portion with a forward end and a rearward end, the body portion having an opening extending therethrough with the connecting member passing slidably through the opening so that the body portion is rotatably mounted on the connecting member, and the float having a fin member extending from the body portion, the fin member having a leading edge and a spaced trailing edge with a pressure surface extending therebetween;
wherein the pressure surface of the fin member is adapted to respond to water pressure when the float is moved through water to rotate the float and intermittently splash the water.

2. The float fishing apparatus of claim 1 wherein the fin member is shaped like a propeller blade such that the pressure surface is an angled surface.

3. The float fishing apparatus of claim 1 wherein the fin member extends around only a portion of the body portion such that the float has an asymmetrical shape.

4. The float fishing apparatus of claim 1 wherein the body portion is slidably mounted on the connecting member.

5. The float fishing apparatus of claim 1 wherein the forward end of the body portion of the float has a generally convex surface.

6. The float fishing apparatus of claim 1 further comprising a first line attachment member at the first end of the connecting member and a second line attachment member at the second end of the connecting member.

7. The float fishing apparatus of claim 1 wherein the connecting member is a wire.

8. A float fishing apparatus, comprising:
an elongated connecting member having a first end and a second end;
a float comprising:
a first body portion with a forward end and a rearward end, the body portion having an opening extending therethrough with the connecting member passing slidably through the opening and the body portion rotatably mounted on the connecting member,
a fin member extending from the body portion, the fin member having a leading edge and a spaced trailing edge with a pressure surface extending therebetween, and
a second body portion with a forward end and a rearward end, the second body portion having an opening extending therethrough with the connecting member passing through the opening, the second body portion spaced apart from and positioned rearward of the first body portion on the connecting member;
wherein the pressure surface of the fin member is adapted to respond to water pressure when the float is moved through water to rotate the first body portion of the float and intermittently splash the water.

9. The float fishing apparatus of claim 8 wherein the second body portion is fixed to the connecting member.

10. The float fishing apparatus of claim 8 wherein the fin member is shaped like a propeller blade such that the pressure surface is an angled surface.

11. The float fishing apparatus of claim 8 wherein the fin member extends around only a portion of the first body portion such that the float has an asymmetrical shape.

12. The float fishing apparatus of claim 8 wherein the forward end of the first body portion of the float has a generally convex surface.

13. The float fishing apparatus of claim 8 further comprising a first line attachment member at the first end of the connecting member and a second line attachment member at the second end of the connecting member.

14. The float fishing apparatus of claim 13 wherein a lure is secured to the second line attachment member proximate the rearward end of the second body portion of the float.

15. The float fishing apparatus of claim 8 wherein the first body portion and the fin member are integrally formed.

16. A float fishing apparatus, comprising:
an elongated connecting member having a first end and a second end;
a float comprising:
a first body portion with a forward end and a rearward end and a centerline extending therebetween, the first body portion having an opening extending along the centerline with the connecting member passing slidably through the opening and the first body portion rotatably mounted on the connecting member,
a first fin member extending from the body portion, the fin member having a leading edge and a spaced trailing edge with a pressure surface extending therebetween,
a second body portion with a forward end and a rearward end and the centerline extending therebetween, the second body portion having an opening extending along the centerline with the connecting member passing through the opening, the second body portion spaced apart from and positioned rearward of the first body portion on the connecting member;
a second fin member extending from the second body portion, the second fin member having a leading edge and a spaced trailing edge with a pressure surface extending therebetween, and
wherein the pressure surface of the first fin member is adapted to respond to water pressure when the float is moved through water to rotate the first body portion of the float and intermittently splash the water and the pressure surface of the second fin member is adapted to respond to water pressure when the float is moved through the water to rotate the second body portion of the float and intermittently splash the water.

17. The float fishing apparatus of claim 16 wherein the first fin member is adapted to rotate the first body portion in a first direction and the second fin member is adapted to rotate the second body portion in an opposite second direction.

18. The float fishing apparatus of claim 17 wherein the first fin member is a first size and the second fin member is a second size, wherein the first size is different than the second size.

19. The float fishing apparatus of claim 17 wherein the first fin member is adapted to rotate the first body portion at a first speed and the second fin member is adapted to rotate the second body portion at a second speed, wherein the first speed is different from the second speed.

20. The float fishing apparatus of claim 17 wherein the first fin member is shaped differently than the second fin member.

21. The float fishing apparatus of claim 20 wherein the first fin member is adapted to rotate the first body portion at a first speed and the second fin member is adapted to rotate the second body portion at a second speed, wherein the first speed is different from the second speed.

22. A method of fishing comprising:
taking a float fishing apparatus including an elongated connecting member having a first end and a second end, a float having a body portion with a forward end and a rearward end and a centerline extending therebetween, the body portion having an opening extending along the centerline with the connecting member passing slidably through the opening and the body portion rotatably mounted on the connecting member, and the float having a fin member extending from the body portion, the fin member having a leading edge and a spaced trailing edge with a pressure surface extending therebetween;
securing a lure to one of the first and second ends of the connecting member nearest the rearward end of the body portion of the float;
casting the float fishing apparatus with the lure a distance;
moving the float through the water wherein the pressure surface of the fin member responds to water pressure to rotate the float and intermittently splash the water.

23. The method of claim 22 wherein the pressure surface of the fin member has a generally concave shape.

24. The method of claim 22 wherein the fin member extends around only a portion of the body portion such that the float has an asymmetrical shape.

25. A float fishing apparatus substantially as described and shown herein.
